(19) United States
(12) Patent Application Publication
(10) Pub. No.: US 2013/0174093 A1
(43) Pub. Date: Jul. 4, 2013

(54) COMPASS MENU

(71) Applicants: Johan Christiaan Peters, Sankt Leon-Rot (DE); Udo Arend, Heidelberg (DE); Vera Legisa, Karlsruhe (DE)

(72) Inventors: Johan Christiaan Peters, Sankt Leon-Rot (DE); Udo Arend, Heidelberg (DE); Vera Legisa, Karlsruhe (DE)

(73) Assignee: SAP AG, Walldorf (DE)

(21) Appl. No.: 13/340,466

(22) Filed: Dec. 29, 2011

(51) Int. Cl. G06F 3/048

(52) U.S. Cl. 715/834

(57) ABSTRACT

A compass menu is generated as a graphical user interface for an application of a computer. The graphical user interface has a compass structure with at least four branches adjacent to a central button. The graphical user interface receives a user selection on the compass structure. A menu is generated based on the user selection on the compass structure and a context of the application. The menu is displayed adjacent to the compass structure.

### FIELD

The present disclosure relates generally to a user interface tool, and in a specific example embodiment, to a compass menu.

### BACKGROUND

A common user interface includes an image of an arrow generated on a display of a computer. The movement and action of the arrow are associated with a user interaction with a mouse or a track pad. On a mouse, the user typically right clicks or left clicks to interact with an application of the computer. Commonly, the right click action triggers an operation such as selecting a function pointed by the arrow. In some applications, the left click action presents the user with a list of options. However, such list of options may not be intuitive to the user when navigating through applications. For example, if a desired function is not listed in the list of options when the user right-clicks, the user would have to navigate back to a toolbar within the application to retrieve the desired function. As such, a user may have to navigate back and forth between the toolbar of the application and the actual document in the application, resulting in inefficiencies. Furthermore, the list of options includes a predefined number of functions that may be irrelevant to the context of a document being worked on within an application.

### BRIEF DESCRIPTION OF DRAWINGS

The appended drawings merely illustrate example embodiments of the present invention and cannot be considered as limiting its scope.

FIG. 1 is a block diagram illustrating an example of a system in which embodiments may be practiced.

FIG. 2 is a block diagram illustrating a collaboration cloud application having a compass menu, in accordance with an example embodiment.

FIG. 3 is a block diagram illustrating an example embodiment of a compass menu module.

FIG. 4 is a block diagram illustrating another example embodiment of a user interface of the collaboration cloud application.

FIG. 5 is a block diagram illustrating a screenshot of an example embodiment of a user interface of the collaboration cloud application.

FIG. 6 is a block diagram illustrating an example embodiment of a graphical user interface of a compass menu.

FIG. 7A is a block diagram illustrating a screenshot of an example embodiment of the compass menu when a user clicks on a right branch.

FIG. 7B is a block diagram illustrating a screenshot of an example embodiment of the compass menu when a user clicks on a top branch.

FIG. 7C is a block diagram illustrating a screenshot of an example embodiment of the compass menu when a user clicks on a left branch.

FIG. 8 is a flowchart of a method, in accordance with an example embodiment, for generating a graphical user interface having a compass structure.

FIG. 9 is a flowchart of a method, in accordance with an example embodiment, operating a compass menu in a business process application.

FIG. 10 is a block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments. It will be evident, however, to those skilled in the art that embodiments of the inventive subject matter may be practiced without these specific details. In general, well-known instruction instances, protocols, structures, and techniques have not been shown in detail.

Example systems and methods to generate and use a compass menu are described. In one example embodiment, a compass menu is generated as a graphical user interface for an application of a computer. The graphical user interface has a compass structure with four branches adjacent to a central button. The graphical user interface receives a user selection on the compass structure. A menu is generated based on the user selection on the compass structure. The menu is displayed adjacent to the compass structure.

In one embodiment, the compass structure is displayed in response to a user action on a control device (e.g. a mouse or a trackpad) of the computer. The compass menu module receives the user selection on one of the four branches or the central button of the compass structure. A first branch (e.g., top branch) of the compass structure corresponds to a first menu. A second branch (e.g., top branch) of the compass structure corresponds to a second menu. A third branch (e.g., top branch) of the compass structure corresponds to a third menu. A fourth branch (e.g., top branch) of the compass structure corresponds to a fourth menu. The central button corresponds to a fifth menu.

In one embodiment, the menu is dynamically generated based on a context of the application. For example, if the context is a business task (e.g, hiring an employee of an organization), the first menu comprises the next process steps of a process of the business task. The second menu comprises a navigation history of the user in business task of the application. The third menu comprises previous process steps of the process of the business task. The fourth menu comprises objects and documents related to the process of the business task. The central button of the compass structure may be used for activating or switching to another business task (e.g., processing an employee complaint) within the application.

In another embodiment, the business task is generated or selected by a user/participant. Participants of the business task, the process of the business task, communications among participants, documents and objects associated with the business task are determined. A collaborative display is generated for the business task for the participants to collaborate on the business task. The collaborative display identifies the participants of the business task, the process of the business task, the communications among participants, and the documents and objects associated with the business task.

In another embodiment, the collaborative display is updated based on participants identified in the business task, a status of the process of the business task, communications among participants, and updated documents and objects associated with the business task.

In another embodiment, a template associated with the business task is determined. The process of the business task is generated based on the template.

In another embodiment, the user interface has a first section to identify the business task, a second section to identify participants of the business task, a third section to display communications between participants of the business task, a fourth section to provide the process of the business task, and a fifth section to provide documents and objects associated with the business task.

In one embodiment, the user interface filters messages associated with the business task from an inbox email of a participant and integrates the filtered messages and other communications related to the business task in the third section of the user interface.

In one embodiment, the user interface displays a status of the process of the business task in the fourth section of the user interface, completed steps of the process of the business task in the fourth section of the user interface, remaining steps of the process of the business task in the fourth section of the user interface, and participants associated with the status, the completed steps and the remaining steps of the process of the business task in the fourth section of the user interface.

In one embodiment, the user interface generates a thumbnail view of the objects and documents associated with the business task in the fifth section based on a status of the process of the business task. Each thumbnail view of each object or document is associated with a corresponding application.

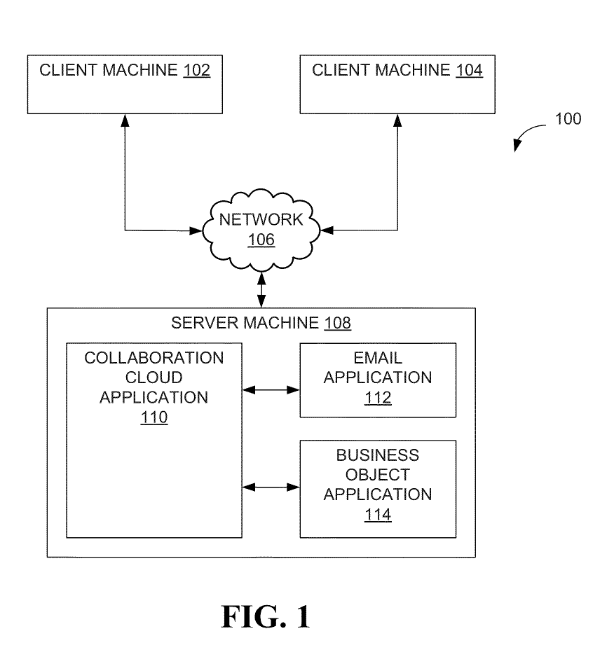

FIG. 1 is a block diagram depicting an example environment 100 within which example embodiments may be deployed. The environment 100 includes one or more client machines (e.g., client machines 102, 104). For example, the client machines 102, 104 may be a personal computer, or a mobile computing device of participants of a business task.

In one embodiment, the client machine 102 may be used to access elements or processes of the business task. For example, a user interface may be provided for the participants to collaborate on the business task. The client machine 102 may execute a web browser (not shown) or a software application (not shown). For example, the web browser may be any browser commonly used to access a network of computers such as the World Wide Web. The web browser may load a user interface to collaborate on the business task. In another embodiment, the software application may load a user interface to collaborate on the business task. In another embodiment, the web browser or the software application may display a visual representation of the business process in the user interface.

The environment 100 includes a server machine 108. The server machine 108 executes one or more applications: a collaboration cloud application 110, an email application 112, a business object application 114.

The business object application 114 defines the process of a business task. For example, various participants need to perform several steps in the process of hiring an employee. A manager may request a job requisition for approval from a superior. In one embodiment, the business object application 114 may process a business task with business objects. For example, a business object may correspond to one or more entities within the business object application 114 that represent things in a business to which the business object application 114 pertains. For example, the business object may map a source data structure in a database to business terms used by non-Information Technology analysts. The business object may also correspond to a function of a database or the business object application 114. For example, if the business object application 114 is a Human Resources application pertaining to recruiting of candidates for job openings within a company, the business object may correspond to a person (e.g., a job candidate) who has applied for a job opening. The business object may include one or more data items. The data items of the business object may correspond to any data that one or more additional applications maintain with respect to the business object. For example, the data item may be a resume of a person (e.g., a candidate for an open position at a company) represented by the business object or the data item may be a time card of a person (e.g., an employee of a company) represented by the business object.

In one embodiment, the email application 112 may be configured to enable the participants of the business task to communicate with each other and others (individual or group emails). The email application 112 may include a convention email server application, such as Exchange of Microsoft.

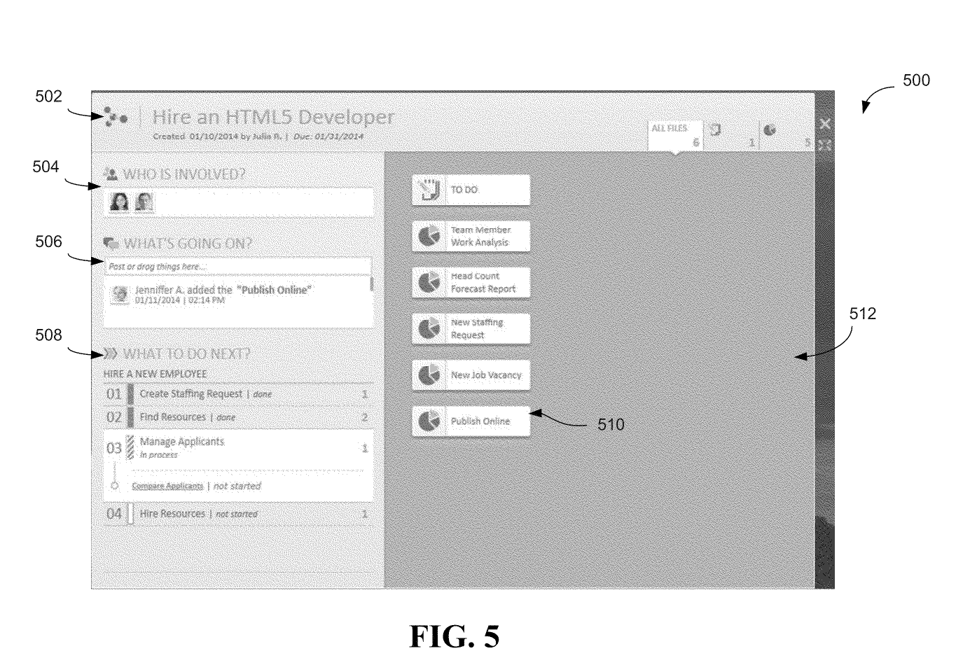

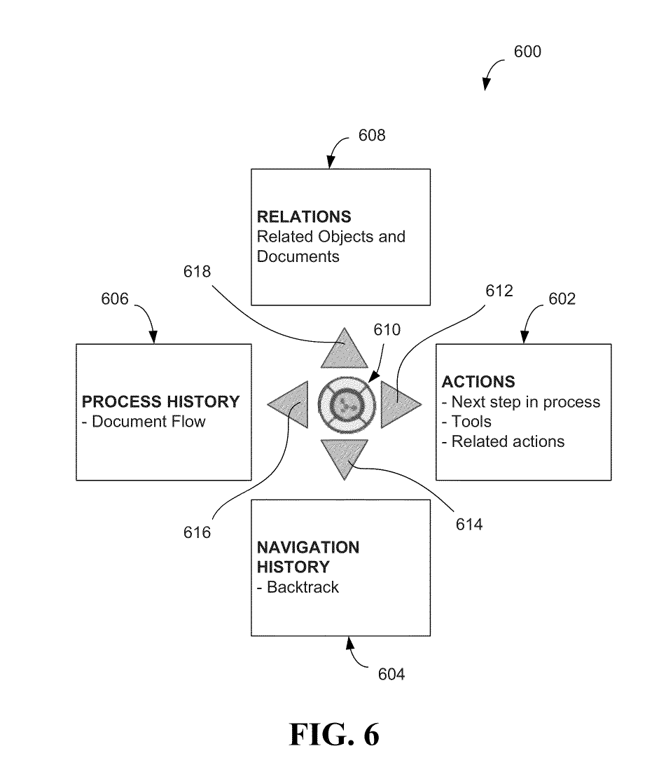

The collaboration cloud application 110 enables participants to collaborate on a business task by updating data from the email application 112 and from the business object application 114. The collaboration cloud application 110 then presents the aggregated information and data in a single user interface dedicated to the business task. In other words, the collaboration cloud application 110 allows to place things and people on it and to share it with others to support collective work. The collaboration cloud application 110 provides a named container on the desktop of a computer to temporarily place things for one dedicated business task, and to integrate feeds combined with an inbox for the dedicated purpose of its usage. Additionally, a process advisor template can be instantiated within the collaboration cloud application 110 to guide users/participants through a business task. For example, a single user interface may be designed and associated with the business task of hiring an employee. The business process application may be configured to process business objects associated with the business task (e.g, hiring an employee). The user interface is described in more detail below with respect to FIG. 4 and FIG. 5.

The client machines 102, 104, and the server machine 108 may be coupled to each other via a network 106. The network 106 enables communication between systems. Accordingly, the network 106 may be a mobile telephone network, a Plain Old Telephone (POTS) network, a wired network, a wireless network (e.g., a WiFi or WiMax network), or any suitable combination thereof. The communication may be based on any communication protocols. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 120 may be implemented using the Internet, a wide area network (WAN), a local area network (LAN), or any suitable combination thereof.

It should be noted that the user interface may generated at the server machine 108 and as such, can be accessible from any client machine.

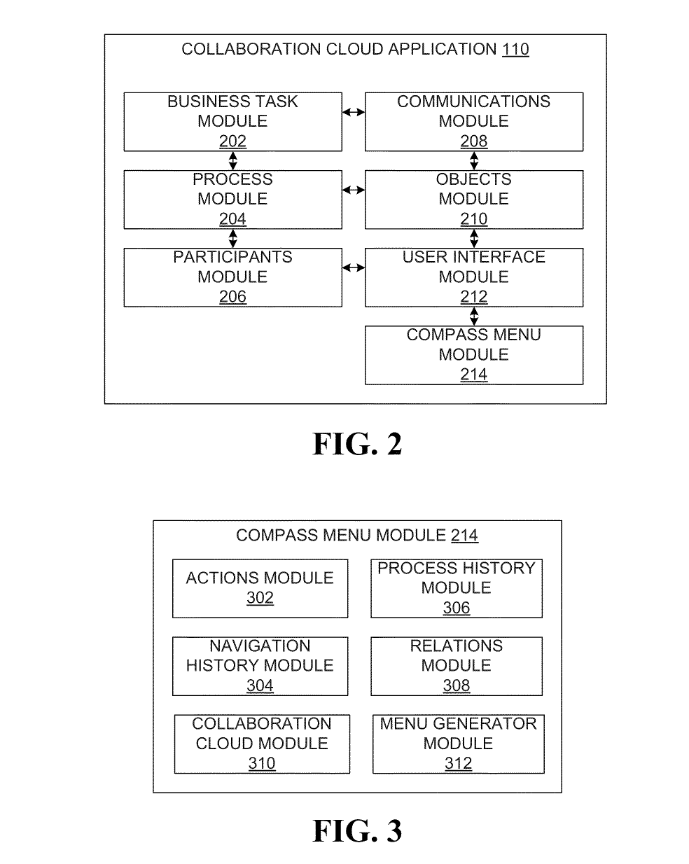

FIG. 2 is a block diagram illustrating the collaboration cloud application 110, in accordance with an example embodiment. The collaboration cloud application 110 may include a business task module 202, a process module 204, a participants module 206, a communications module 208, an objects module 210, a user interface module 212, and a compass menu module 214.

The business task module 202 generates a business task (e.g., hiring an employee, generating a purchase order for a manufacturing component, and so forth). The business task may be generated by a user or retrieved from an existing library of business tasks.

The process module 204 determines a process of the business task. The business task involves several steps to be completed by identified participants of the business task. For example, if the business task is hiring an employee, the process includes receiving a job requisition request from a manager, getting approval from a superior, posting the job requisition, receiving resumes and emails in response to the job posting, selecting candidates for interview, scheduling interviewers associated with the job requisition, receiving feedback from the interviewers, and so forth.

In one embodiment, the business task may be retrieved from a database, or generated using a business task template. For example, the process of hiring an employee would also be applicable from a sales department of an organization to an information technology (IT) department of the same organization.

The participants module 206 identifies participants of the business task. For example, participants of the business tasks of hiring an employee include an HR personal, a manager, a supervisor, and so forth. The participants may vary depending on the business task. For example, the business task of generating a purchase order may involve personal from the accounting and engineering department. The business task of fulfilling a sales order may involve personal from the sales and accounts receivable department. As such, the participants module 206 identifies the participants based on the business task. In another embodiment, the identification of the participants is updated based on a status or process in the business task. For example, a supervisor may not be identified as a participant once the candidate has been hired. A new participant in the business process would include an HR benefits coordinator at that stage in the process of the business task.

The communications module 208 tracks communications among participants related to the business task. For example, emails, chats, and instant messages that are related to the business task may be filtered and used by the collaboration cloud application 110. The communications module 208 may interface with common email servers or clients, or instant messages applications. The communications module 208 may allow a participant to communicate within the user interface to other participants. In other words, the communications module 208 allows a participant to send and receive communications related to the business task. In another embodiment, the communications module 208 enables a participant to invite or remove other participants. A status for an object or document may also be set using the communications module 208. In yet another embodiment, the communications module 208 may interface with a calendar or another third-party communication application.

The objects module 210 identifies documents and objects associated with the business task. For example, documents associated with the business task may include written documents, websites links, documents related to the business task, spreadsheets related to the business task, PDF documents, and so forth. The documents may also include multimedia documents such as module and/or video. The objects may include drawings, shortcuts to applications relevant to the business task, and multimedia objects. For example, when a user clicks on a document, the corresponding application opens up the document.

In another embodiment, objects may be dragged and dropped into and out of an object and document area. Objects may be grouped together based on their functionalities or commonalities. For example, spreadsheets may be grouped together. Objects may also be filtered with a switchable filter according to an object type.

The user interface module 212 generates a collaborative display for the business task for the participants to collaborate on the business task. The collaborative display identifies the participants of the business task, the process of the business task, the communications among participants related to the business task, and the documents and objects associated with the business task. The collaborative display may also be referred to as a user interface.

The compass menu module 214 generates a graphical user interface for an application of a computer. In one embodiment, the graphical user interface includes a compass structure with four branches (e.g., top, bottom, right, and left) adjacent to a central button. The compass menu module 214 is described in more detail below.

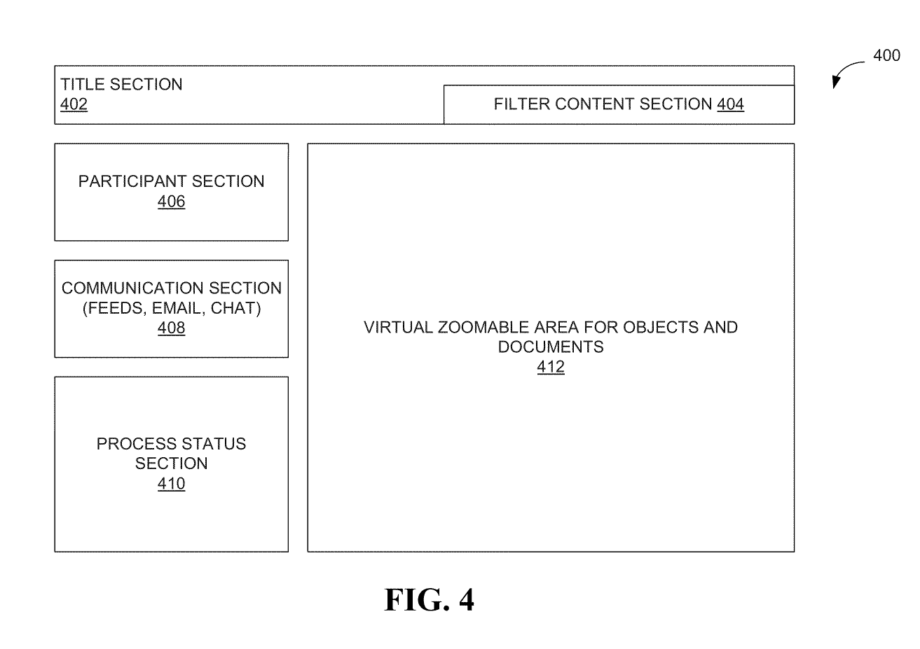

FIG. 3 is a block diagram illustrating an example embodiment of the compass menu module 214. The compass menu module 214 includes, for example, an actions module 302, a process history module 306, a relations module 308, a collaboration cloud module 310, and a menu generator module 312.

The actions module 302 generates a first branch of the compass structure corresponding to a first menu. For example, the first menu includes actions to be completed in a process of a business task. In other words, the first menu includes a list of what can be done next to complete the process: ask for approval, ask for clarification, send an email, and so forth.

The navigation history module 304 generates a second branch of the compass structure corresponding to a second menu. For example, the second menu may include a history of where the user has navigated in the application with respect to a particular business task.

The process history module 306 generates a third branch of the compass structure corresponding to a third menu. For example, the third menu may include a document flow. In other words, the third menu may show a history of a same document to show a flow of the different versions of the same document.

The relations module 308 generates a fourth branch of the compass structure corresponding to a fourth menu. For example, the fourth menu may include contacts and relationships with other participants of the business task. In another example, the fourth menu may include a list of related objects and documents related to the business task.

The collaboration cloud module 310 generates the central button corresponding to a fifth menu. In another embodiment, the central button does not generate a menu but directly operates on a function. For example, the user may switch to another business task of the business application by clicking on the central button.

The menu generator module 312 receives the user selection on one of the four branches and/or the central button of the compass structure and generates a dynamic menu based on the module corresponding to the selected branch or central button. For example, when a user clicks on relations module, functions listed in the menu are based on the relationship with other participants and the business task. For instance, “ask for approval” may appear if the user/participant reports to a supervisor.

FIG. 4 is a block diagram illustrating an example embodiment of a user interface 400 of the collaboration cloud application. The user interface 400 includes, for example, a title section 402, a filter content section 404, a participant section 406, a communication section 408, a process status section 410, and a virtual zoomable area for objects and documents.

The title section 402 identifies a name of the business task. For example, the name of the business task may be “Hire an HTML 5 Developer.” The filter content section 404 allows a user of the collaboration cloud application to filter out content in the canvas or working area (objects and documents area) based on a user-specified criteria.

The participant section 406 identifies the names of all participants associated with the business task named in title section 402. In another embodiment, the participant section 406 is updated to identify the name of participants based on an updated status of the process of the business task.

The communication section 408 provides a means for a participant to communicate with other participants of the business task. For example, the communication section 408 may provide a chat window or an e-mail window or a feed window to enable communication with other participants of the business task. In one embodiment, the communication section 408 may include an instant messaging interface for communication with the other participants of the business task. In another embodiment, the communication section 408 retrieves e-mails from a participant's e-mail account where the e-mails are relevant and related to the business task soul asked to provide a consolidated user interface for activities related the business task.

The process status section 410 displays the process of the business task. For example, steps to achieve the business task are listed. In one embodiment, each step is associated with identified participants. The process status section 410 may also indicate which steps have been completed, and which steps still need to be completed. In another embodiment, the process status section 410 may also display the process on a timeline.

The virtual zoomable area for objects and documents 412 provide a container area for documents and objects to be placed. The objects and documents may be associated with each step of the process of the business task. For example, a document may be generated based on the status of a step of the process of the business task. In the example of hiring an employee, feedback from interviewers may be collected and aggregated in a single spreadsheet document that is accessible in the virtual zoomable area 412.

FIG. 5 is a block diagram illustrating another example embodiment of a business process area of a user interface 500 of the collaboration cloud application. The user interface 500 includes a title section 502, a participant section 504, a communication section 506, a process status section 508, a documents and objects area 512.

The title section 502 relates to the present business task of hiring an HTML 5 developer.

The participant section 504 illustrates who is involved with the business task titled in section 502. In one embodiment, thumbnail pictures of participants may be displayed.

The communication section 506 illustrates activities performed by other participants with respect to the business task. For example, a document 510 has been added to the documents and objects area 512. In another embodiment, the communication section 506 illustrates communications between participants in a chat format. The communication area 506 may provide a selectable chat function from a participant to another participant. In another embodiment, the participant may be able to communicate with a user outside the participants identified in identification area 502.

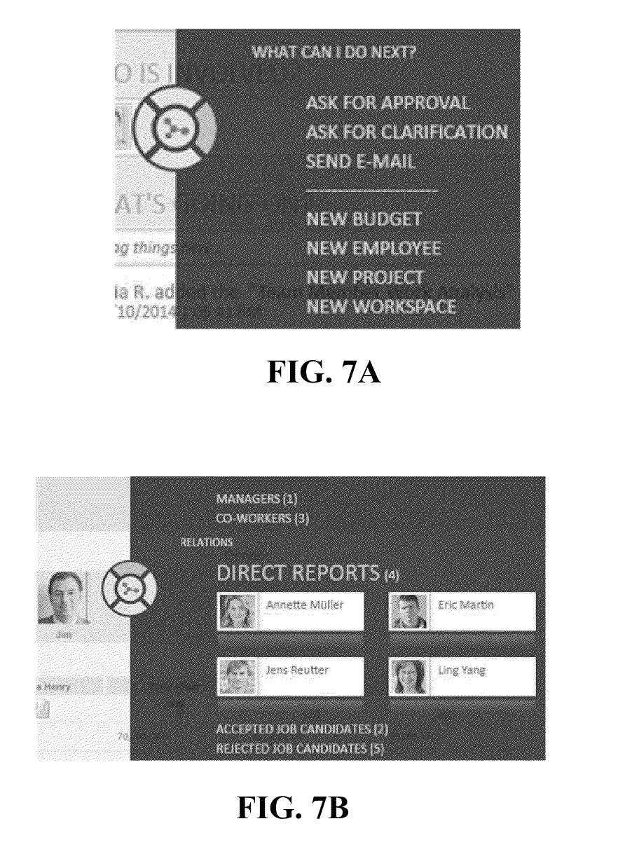

FIG. 6 is a block diagram illustrating an example embodiment of a graphical user interface of a compass menu 600. The compass menu 600 includes four branches 612, 614, 616, and 618 corresponding to menus 602, 604, 606, and 608. When a user clicks on a branch, the corresponding menu is displayed. For example, the branch 612 corresponds to the actions menu 602 (e.g., next step in process, tools, related actions). The branch 614 corresponds to the navigation history menu 604 (e.g., backtrack). The branch 616 corresponds to the process history menu 606 (e.g., document flow). The branch 618 corresponds to the relations menu 608 (e.g., related objects and documents). The central button 610 enables a function or may generate another menu.

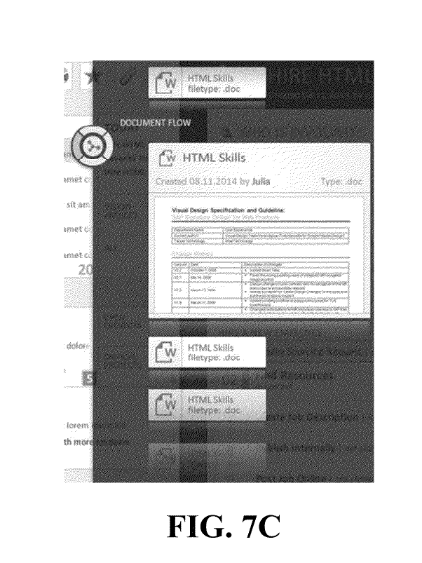

FIG. 7A illustrates a screenshot of an example embodiment of the compass menu illustrating the action menu when a user clicks on the branch 612.

FIG. 7B illustrates a screenshot of an example embodiment of the compass menu illustrating the relations menu when a user clicks on the branch 618.

FIG. 7C illustrates a screenshot of an example embodiment of the compass menu illustrating the process history when a user clicks on the branch 606.

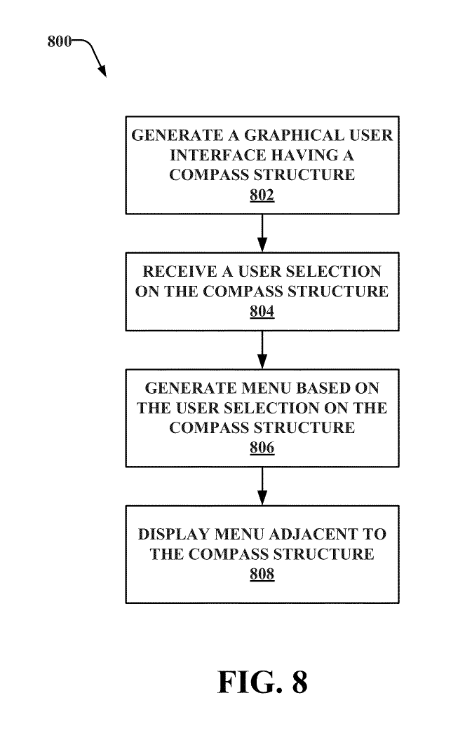

FIG. 8 is a flowchart 800 of a method, in accordance with an example embodiment, for generating a graphical user interface having a compass structure. At operation 802, a graphical user interface for an application of a computer is generated. In one embodiment, the graphical user interface has a compass structure with four branches adjacent to a central button.

At operation 804, a user selection on the compass structure is received. In one embodiment, the compass menu module 214 is configured to detect the user selection.

At operation 806, a menu is generated based on the user selection on the compass structure. In one embodiment, the menu generator module 312 is configured to generate the corresponding menu based on the context of the application.

At operation 808, the menu is displayed adjacent to the compass structure. In one embodiment, the corresponding menu module generates the corresponding menu of functions and/or options for the user to select.

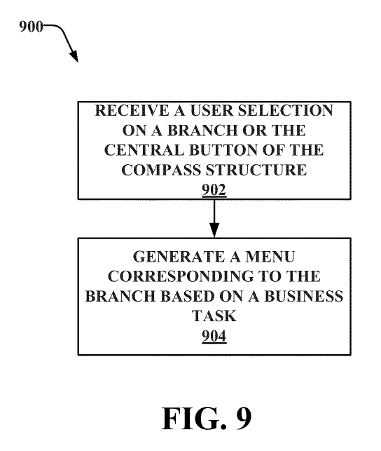

FIG. 9 is a flowchart 900 of a method, in accordance with an example embodiment, operating a compass menu in a business process application. At operation 902, a user selection of a branch or a central button of a compass structure is received or detected. In one embodiment, the compass menu module 214 detects the user selection. At operation 904, a menu corresponding to the selected branch is generated based on the business task.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

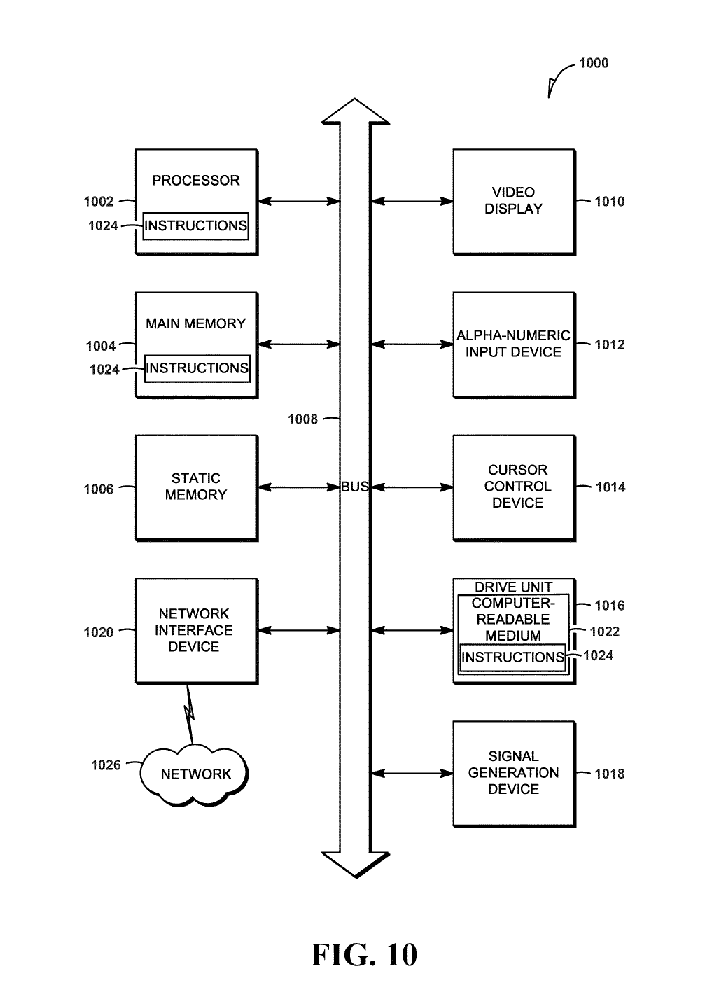

With reference to FIG. 10, an example embodiment extends to a machine in the example form of a computer system 1000 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 may include a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). In example embodiments, the computer system 1000 also includes one or more of an alpha-numeric input device 1012 (e.g., a keyboard), a user interface (UI) navigation device or cursor control device 1014 (e.g., a mouse), a disk drive unit 1016, a signal generation device 1018 (e.g., a speaker), and a network interface device 1020.

The disk drive unit 1016 includes a machine-readable storage medium 1022 on which is stored one or more sets of instructions 1024 and data structures (e.g., software instructions) embodying or used by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media.

While the machine-readable storage medium 1022 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present description, or that is capable of storing, encoding, or carrying data structures used by or associated with such instructions. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

It should be noted that various modifications and changes may be made to these example embodiments without departing from the broader spirit and scope of the present invention.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of the example embodiments as represented by the appended claims. The specification and drawings are, accordingly, to be regarded in an illustrative rather than a restrictive sense.

What is claimed is:

1. A computer-implemented method comprising:
generating a graphical user interface for an application of a computer, the graphical user interface having a compass structure with four branches adjacent to a central button;
receiving a user selection on the compass structure;
generating, using a processor of the computer, a menu based on the user selection on the compass structure and on a context of the application; and
displaying the menu adjacent to the compass structure.

2. The computer-implemented method of claim 1, further comprising:
displaying the compass structure in response to a user action on a control device of the computer.

3. The computer-implemented method of claim 2, wherein receiving further comprises:
receiving the user selection on one of the four branches or the central button of the compass structure, a first branch of the compass structure corresponding to a first menu, a second branch of the compass structure corresponding to a second menu, a third branch of the compass structure corresponding to a third menu, a fourth branch of the compass structure corresponding to a fourth menu, and the central button corresponding to a fifth menu.

4. The computer-implemented method of claim 3, wherein the menu is dynamically generated based on the context of the application.

5. The computer-implemented method of claim 4, wherein the context comprises a business task, the first menu comprising next process steps of a process of the business task, the second menu comprising a navigation history of the user in business task of the application, the third menu comprising previous process steps of the process of the business task, the fourth menu comprising objects and documents related to the process of the business task, and the central button for activating another business task of the application.

6. The computer-implemented method of claim 5, further comprising:
generating, using at least one processor, the business task;
determining participants of the business task, the process of the business task, communications among participants, documents and objects associated with the business task; and
generating a collaborative display for the business task for the participants to collaborate on the business task, the collaborative display identifying the participants of the business task, the process of the business task, the communications among participants, the documents and objects associated with the business task.

7. The computer-implemented method of claim 6, further comprising:
updating the collaborative display based on participants identified in the business task, a status of the process of the business task, communications among participants, updated documents and objects associated with the business task.

8. The computer-implemented method of claim 6, wherein generating the business task comprises:
determining a template associated with the business task; and
generating the process of the business task based on the template.

9. The computer-implemented method of claim 6, wherein generating the collaborative display further comprises:
generating a user interface having a first section to identify the business task, a second section to identify participants of the business task, a third section to display communications between participants of the business task, a fourth section to provide the process of the business task, and a fifth section to provide documents and objects associated with the business task.

10. The computer-implemented method of claim 9, wherein generating the user interface further comprises:
filtering messages associated with the business task from an inbox email of a participant; and
integrating the filtered messages and other communications related to the business task in the third section of the user interface.

11. The computer-implemented method of claim 9, wherein generating the user interface further comprises:
displaying a status of the process of the business task in the fourth section of the user interface;
displaying completed steps of the process of the business task in the fourth section of the user interface;
displaying remaining steps of the process of the business task in the fourth section of the user interface; and
displaying participants associated with the status, the completed steps and the remaining steps of the process of the business task in the fourth section of the user interface.

12. The computer-implemented method of claim 9, wherein generating the user interface further comprises:
displaying a thumbnail view of the objects and documents associated with the business task in the fifth section based on a status of the process of the business task, wherein each thumbnail view of each object or document is associated with a corresponding application.

13. A system comprising:
a processor comprising a compass menu module, the compass menu module configured to generate a graphical user interface for an application of a computer, the graphical user interface having a compass structure with four branches adjacent to a central button; and
a menu generator configured to receive a user selection on the compass structure, to generate a menu based on the user selection on the compass structure and on a context of the application, and to display the menu adjacent to the compass structure.

14. The system of claim 13, wherein the menu generator is configured to display the compass structure in response to a user action on a control device of the computer.

15. The system of claim 14, wherein the menu generator is configured to receive the user selection on one of the four branches or the central button of the compass structure, the compass menu module comprising:
an actions module configured to generate a first branch of the compass structure corresponding to a first menu;
a navigation history module configured to generate a second branch of the compass structure corresponding to a second menu;
a process history module configured to generate a third branch of the compass structure corresponding to a third menu;
a relations module configured to generate a fourth branch of the compass structure corresponding to a fourth menu; and
a collaboration cloud module configured to generate the central button corresponding to a fifth menu.

16. The system of claim 15, wherein the menu is dynamically generated based on the context of the application.

17. The system of claim 16, wherein the context comprises a business task, the first menu comprising next process steps of a process of the business task, the second menu comprising a navigation history of the user in business task of the application, the third menu comprising previous process steps of the process of the business task, the fourth menu comprising objects and documents related to the process of the business task, and the central button for activating another business task of the application.

18. The system of claim 17, wherein the processor further comprises a business task module, a process module, a participants module, a communications module, an objects module, and a user interface module,
the business task module configured to generate the business task,
the process module configured to determine the process of the business task,
the participants module configured to identifying participants of the business task,
the communications module configured to track communications among participants related to the business task,
the objects module configured to identify documents and objects associated with the business task, and
the user interface module configured to generate a collaborative display for the business task for the participants to collaborate on the business task, the collaborative display identifying the participants of the business task, the process of the business task, the communications among participants related to the business task, and the documents and objects associated with the business task.

19. A non-transitory machine-readable storage medium storing instructions which, when executed by at least one processor, performs operations comprising:
generating a graphical user interface for an application of a computer, the graphical user interface having a compass structure with four branches adjacent to a central button;
receiving a user selection on the compass structure;
generating a menu based on the user selection on the compass structure; and
displaying the menu adjacent to the compass structure.

20. The non-transitory machine-readable storage medium of claim 19, further comprising:
displaying the compass structure in response to a user action on a control device of the computer; and
receiving the user selection on one of the four branches or the central button of the compass structure, a first branch of the compass structure corresponding to a first menu, a second branch of the compass structure corresponding to a second menu, a third branch of the compass structure corresponding to a third menu, a fourth branch of the compass structure corresponding to a fourth menu, and the central button corresponding to a fifth menu,
the menu dynamically generated based on a context of the application, the context comprises a business task, the first menu comprising next process steps of a process of the business task, the second menu comprising a navigation history of the user in business task of the application, the third menu comprising previous process steps of the process of the business task, the fourth menu comprising objects and documents related to the process of the business task, and the central button for activating another business task of the application.
